(19) United States
(12) Patent Application Publication
(10) Pub. No.: US 2007/0216583 A1
(43) Pub. Date: Sep. 20, 2007

(54) Antenna structure for electronic device

(75) Inventor: Kai Chung Hou, Taipei City (TW)

Correspondence Address: QUINTERO LAW OFFICE, PC, 2210 MAIN STREET, SUITE 200, SANTA MONICA, CA, 90405, US

(73) Assignee: LITE-ON TECHNOLOGY CORPORATION, TAIPEI (TW)

(21) Appl. No.: 11/417,796

(22) Filed: May 3, 2006

(30) Foreign Application Priority Data
Mar. 20, 2006 (TW) TW95109454

(51) Int. Cl. H01Q 1/24; H01Q 1/38

(52) U.S. Cl. 343/702; 343/700 MS

(57) ABSTRACT

An antenna structure is disposed on an electronic device comprising a housing and a control circuit disposed in the housing. The antenna structure comprises a film layer, and a patterned conductive layer disposed on the film layer and electrically connected to a control circuit of an electronic device to receive or send a signal, wherein the patterned conductive layer and the film layer are formed on a housing of the electronic device.

### BACKGROUND OF THE INVENTION

1. Field of the Invention

The present invention relates to an antenna structure, and in particular relates to an antenna structure formed on a housing of an electronic device.

2. Description of the Related Art

Antenna for radio devices convert the electrical signals to electromagnetic signals or vice versa. In hand-held electronic devices, the antenna can be external or internal. The external antenna, shown in FIG. 1, protrudes from an electronic device. The internal antenna may be a punched metal plate disposed in the electronic device (FIG. 2), an antenna layer on a flexible printed circuit board (FIG. 3) or folded metal wire disposed in the electronic device (FIG. 4). The antenna of all conventional designs is manufactured by punching or folding as an individual body from an electronic device and assembled thereto with a plastic antenna carrier. The cost, manufacture and assembly are all adversely affected.

### BRIEF SUMMARY OF INVENTION

A detailed description is given in the following embodiments with reference to the accompanying drawings.

An embodiment of an antenna structure of the invention comprises a film layer with a patterned conductive layer disposed thereon and electrically connected to a control circuit of an electronic device to receive or send a signal, wherein the patterned conductive layer and the film layer are formed on a housing of the electronic device.

The patterned conductive layer is between the housing and the film layer.

The patterned conductive layer can be formed on an external side of the housing. The antenna structure further comprises a printed layer formed between the patterned conductive layer and the film layer.

In another embodiment, the patterned conductive layer can be formed on an internal side of the housing.

The patterned conductive layer comprises a metal layer and a graphite layer.

The film layer comprises plastic.

### BRIEF DESCRIPTION OF DRAWINGS

The invention can be more fully understood by reading the subsequent detailed description and examples with references made to the accompanying drawings, wherein:

FIG. 1 is a schematic view of a conventional antenna structure;

FIG. 2 is a schematic view of another conventional antenna structure;

FIG. 3 is a schematic view of another conventional antenna structure;

FIG. 4 is a schematic view of another conventional antenna structure;

FIGS. 5-10 are schematic views of manufacturing the antenna structure of the invention;

FIG. 11 is a schematic view of an antenna structure of the invention formed on an external side of a housing of an electronic device;

FIG. 12 is a schematic view of an antenna structure of the invention formed on an internal side of a housing of an electronic device;

FIG. 13 is a flowchart of manufacturing the antenna structure of the invention; and

FIG. 14 is a flowchart of manufacturing the antenna structure of the invention.

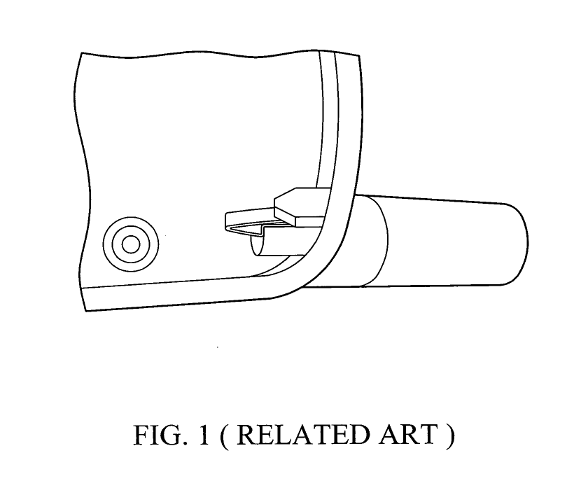

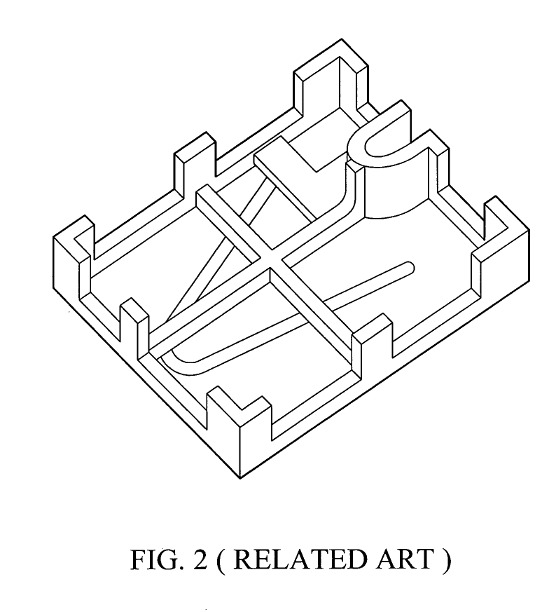

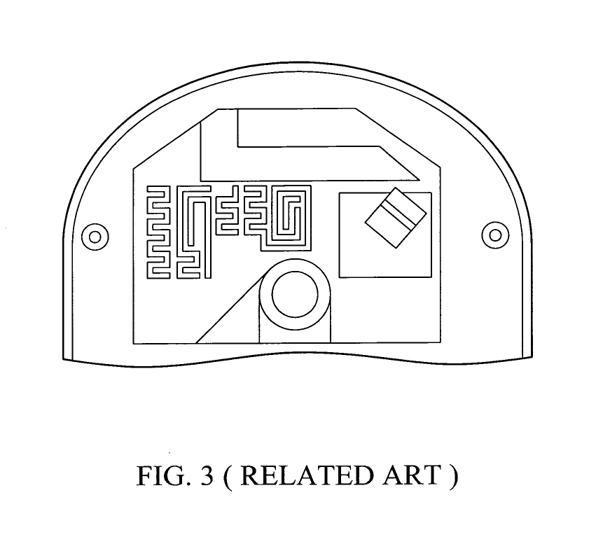

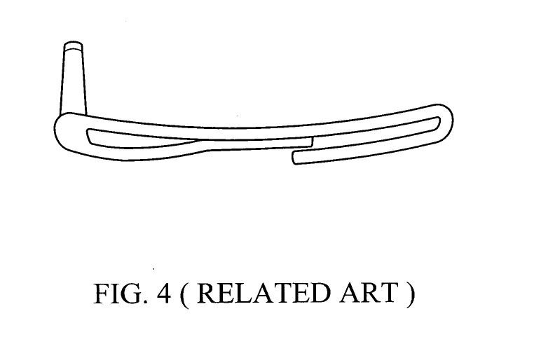

### DETAILED DESCRIPTION OF INVENTION

An antenna structure of the invention is formed on a housing of an electronic device rather than disposed in the housing of the conventional design.

The antenna structure of the invention comprises a patterned conductive layer formed on a film layer to serve as an antenna receiving or sending a signal. The conductive layer is formed on the film layer by selective plating, physical plating, physical plating with laser engraving, graphite or carbon powder printing, thermal pressing of a metal film, or bonding a metal film. The film layer with patterned conductive layer is placed in an injection mold, and IMF (Insert-Mold Film Decoration) manufacture a housing of an electronic device in the injection mold to bond the film layer thereto.

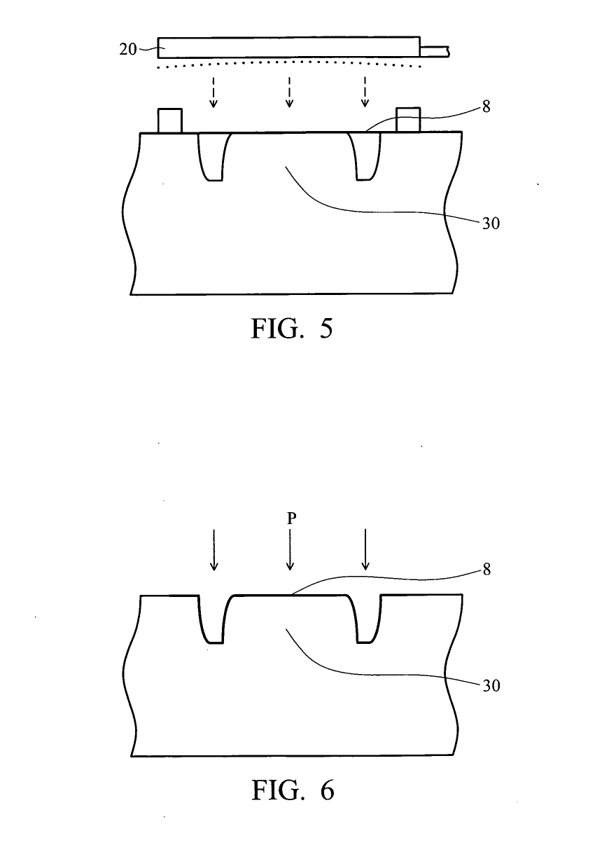

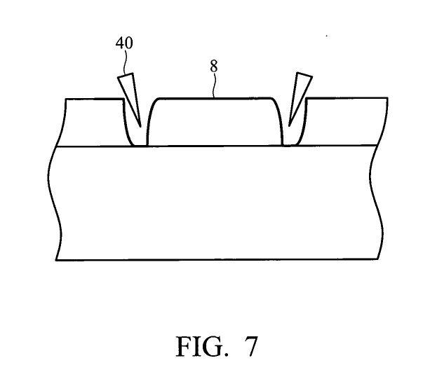

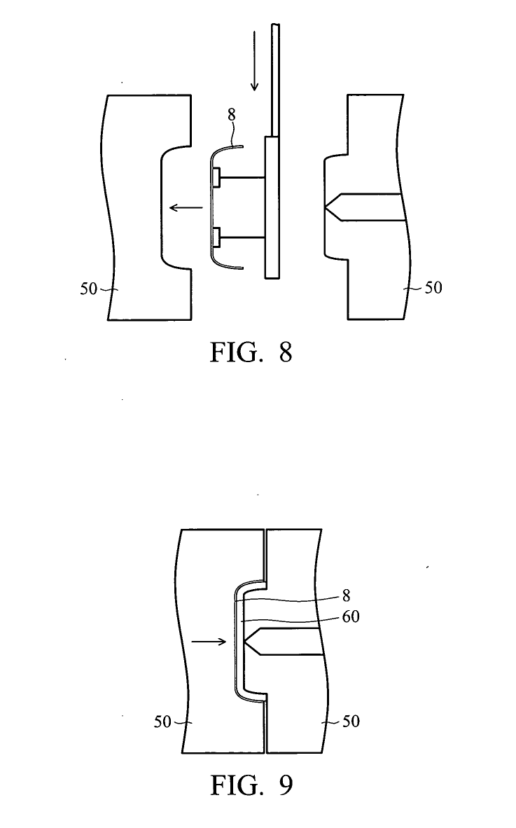

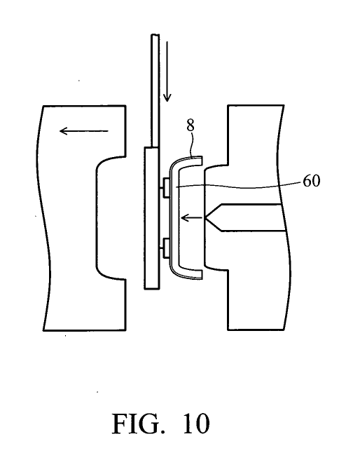

FIGS. 5 to 10 depict the process of the IMF method. A film 8 is used to form the antenna. The film 8 is placed on a thermal pressing mold 30 where the film 8 is heated by a heater 20, as shown in FIG. 5. Pressure P is exerted on the heated film 8 in the thermal pressing mold 30, as shown in FIG. 6. The pressed film 8 is trimmed by a tool 40 to a spatial shape, as shown in FIG. 7. The special film 8 is placed in an injection mold 50, as shown in FIG. 8. Plastic is injected into the injection mold 50 to form a plastic substrate 60, as shown in FIG. 9. The film 8 is parallel bonded to the plastic substrate 60 and integrated with the plastic substrate 60, as shown in FIG. 10.

The described process bonds the film 8 to an antenna layer 10 on the plastic substrate 60 serving as a housing or a part of a housing of an electronic device, such as a mobile phone. The antenna layer 10 can be disposed on an external side or an internal side of the housing (plastic substrate 60). Appropriate holes are reserved on the plastic substrate 60, through which the antenna layer 10 is electrically connected to a control circuit in the housing for transmitting wireless signals if the antenna layer 10 is disposed on the external side of the housing,.

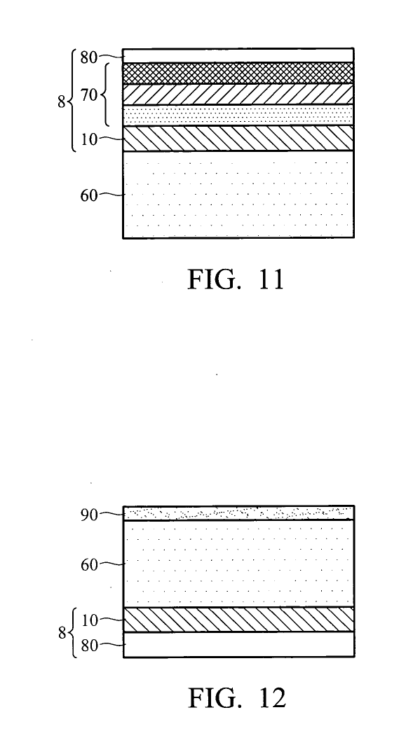

FIG. 11 depicts an embodiment of the invention with the film 8 bonded to the external side of the housing 60. In the IMF method, the antenna layer 10 is printed on a film layer 80, and the antenna 10 and the film layer 80 are processed by the IMF method (FIGS. 5 to 10). The film layer 80 can be transparent or oblique. For artistic purpose, a printed layer 70 is formed on the film layer 80. The printed layer 70 may comprise multi-layers. The antenna layer 10 is printed on the printed layer 70 to serve as the antenna of an electronic device, such as a mobile phone. The film layer 80, the printed layer 70 and the antenna layer 10 are processed by IMF method shown in FIGS. 5 to 10. The film 8 comprises a film layer, an antenna layer 10 and a printed layer 70. In this embodiment, the film layer 80 can be transparent.

FIG. 12 depicts another embodiment of the invention, wherein film 8 is bonded to the internal side of the housing. The film 8 comprises the antenna layer 10 and a film layer 80. For artistic purpose, a painting layer 90 can be formed on the external side of the housing. In this embodiment, the film layer 80 can be transparent or oblique.

The antenna layer 10 comprises graphite or metal. The following flowcharts describe the graphite case and the metal case respectively.

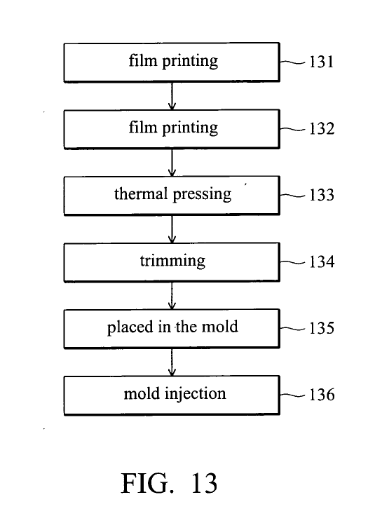

Referring to FIG. 13, the antenna layer 10 is graphite. The printed layer 70 is printed on the transparent film layer 80 (step 131). A graphite layer is printed on the printed layer 70 (step 132). The graphite layer is the antenna layer 10. The antenna layer 10, the printed layer 70, and film layer 80 are pressed in a thermal pressing mold (step 133 corresponding to FIGS. 5 and 6). The pressed film is trimmed (step 134 corresponding to FIG. 7). The antenna layer 10, the printed layer 70 and film layer 80 are placed in an injection mold (step 135 corresponding to FIG. 8). The plastic is injected into the injection mold (step 136 corresponding to FIG. 9).

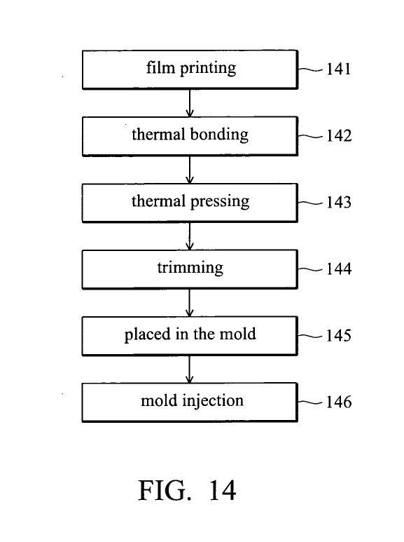

Referring to FIG. 14, the antenna layer is a conductive aluminum foil. The printed layer 70 is printed on the transparent film layer 80 (step 141). The aluminum foil is thermally pressed to the printed layer 70 (step 142). The aluminum foil is the antenna layer 10. The antenna layer 10, the printed layer 70 and film layer 80 are pressed in a thermal pressing mold (step 143 corresponding to FIGS. 5 and 6). The pressed film is trimmed (step 144 corresponding to FIG. 7). The antenna layer 10, the printed layer 70 and film layer 80 are placed in an injection mold (step 145 corresponding to FIG. 8). The plastic is injected into the injection mold (step 146 corresponding to FIG. 9).

The antenna structure of the invention is formed on a housing of an electronic device. The cost for material and mold is reduced, and the yield of the assembly is increased. In addition, as the antenna layer is parallel to the housing, more flexibility is provided for designing the housing.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure disposed on an electronic device comprising a housing and a control circuit disposed in the housing, comprising:
a film layer; and
a patterned conductive layer disposed on the film layer and electrically connected to the control circuit to receive or send a signal, wherein the patterned conductive layer and the film layer are formed on the housing.

2. The antenna structure as claimed in claim 1, wherein the patterned conductive layer is between the housing and the film layer and parallel to the housing.

3. The antenna structure as claimed in claim 1, wherein the patterned conductive layer is formed on an external side of the housing.

4. The antenna structure as claimed in claim 3 further comprising a printed layer formed between the patterned conductive layer and the film layer.

5. The antenna structure as claimed in claim 1, wherein the film layer is transparent.

6. The antenna structure as claimed in claim 1, wherein the film layer is colorized to be a decoration.

7. The antenna structure as claimed in claim 1, wherein the patterned conductive layer is formed on an internal side of the housing.

8. The antenna structure as claimed in claim 1, wherein the patterned conductive layer comprises a metal layer and a graphite layer.

9. The antenna structure as claimed in claim 1, wherein the film layer comprises plastic.

10. The antenna structure as claimed in claim 1, wherein the film layer and the patterned conductive layer are formed on the housing by Insert-Mold Film Decoration method.

11. An electronic device, comprising:
a housing;
a control circuit disposed in the housing;
a film layer; and
an antenna layer comprising a patterned conductive layer formed on the film layer and electrically connected to the control circuit to receive or send a signal, wherein the antenna layer and the film layer are bonded on the housing, and the antenna layer is between the housing and the film layer.
